(19) United States
(12) Patent Application Publication
(10) Pub. No.: US 2026/0130350 A1
(43) Pub. Date: May 14, 2026

(54) BRAKING SYSTEM FOR FISHING REEL

(71) Applicants: Pure Fishing, Inc., Columbia, SC (US); Jia Dun Sports Equipment, Ltd., Guangzhou (CN)

(72) Inventors: Yingdong QI, Guangzhou (CN); Sheng LI, Guangzhou (CN); Guohua ZANG, Guangzhou (CN); Liang HUANG, Guangzhou (CN)

(21) Appl. No.: 19/354,825

(22) Filed: Oct. 9, 2025

(30) Foreign Application Priority Data
Nov. 12, 2024 (CN) 202411607840.4

(51) Int. Cl. A01K 89/0155

(52) U.S. Cl. CPC A01K 89/01555

(57) ABSTRACT

A braking system for a fishing reel is provided, which belongs to the technical field of fishing reels. The braking system includes a braking piece, the braking piece being configured for braking the fishing reel; a detecting device, the detecting device being configured for generating a detection signal according to a rotation speed of a spool; and a control device, the control device being electrically connected with the detecting device and the braking piece respectively, and configured for perform flexible control on a braking force of the braking piece according to the detection signal.

### CROSS REFERENCE TO RELATED APPLICATION

This application is based on and claims the benefit of priority from Chinese Patent Application No. 2024116078404, filed on Nov. 12, 2024, the entirety of which is incorporated by reference herein.

### TECHNICAL FIELD

The present disclosure relates to the technical field of fishing reels, in particular to a braking system for a fishing reel.

### BACKGROUND

In a fishing reel, such as a baitcasting reel, excessive spool rotation speed during a cast can cause the line to leave the spool faster than the lure travels. This causes the line to bunch up around the spool, resulting in “backlash”. To prevent this, a brake system is mounted that applies braking force to the spool.

When the rotation speed of the spool rises to a certain set speed, a braking force suddenly changes to a maximum value. Moreover, when the rotation speed reaches the maximum value, the braking force suddenly drops, for example, suddenly changes to 30% to 50% of the maximum value. The above braking mode will lead to kinetic energy loss and affect a throwing distance during rising. When the rotation speed reaches the maximum, the braking force decreases, which tends to increase a backlash probability of the fishing line. In this way, how to provide a braking system for a fishing reel to achieve smooth braking has become an urgent technical problem.

### PRIOR ART REFERENCE

### Patent Reference

Patent reference 1: China Invention Patent Publication No. 108323485

### SUMMARY

Embodiments of the present disclosure mainly aim at providing a braking system for a fishing reel, which is intended to realize smooth braking.

In order to achieve the above object, a first aspect of the embodiments of the present disclosure provides a braking system for a fishing reel, where the fishing reel includes a spool, and the braking system includes:
a braking piece, where the braking piece is configured for braking the spool;
a detecting device, where the detecting device is configured for generating a detection signal according to a rotation speed of the spool; and
a control device, where the control device is electrically connected with the detecting device and the braking piece respectively, and configured for perform flexible control on a braking force of the braking piece according to the detection signal.

In some embodiments, the control device configured for the flexible control on the braking force of the braking piece according to the detection signal, is further configured to:
perform the flexible control on the braking force of the braking piece in response to determining that the spool is in a casting state according to the detection signal; and
set the braking force of the braking piece as a preset braking force in response to determining that the spool is in a water falling state according to the detection signal.

In some embodiments, the control device includes:
a braking-dial adjusting device, where the braking-dial adjusting device is configured for setting a braking force intensity level;
a braking control switch, where the braking control switch is electrically connected with the braking piece; and
a master control module, where the master control module is electrically connected with the braking-dial adjusting device, the braking control switch and the detecting device respectively, and is configured for controlling an on-state and an on-time of the braking control switch according to the detection signal and the braking force intensity level, so as to perform flexible control of the braking force of the braking piece.

In some embodiments, the braking control switch includes:
an MOS transistor, where the MOS transistor is electrically connected with the braking piece; and
a braking control unit, where the braking control unit is configured for being electrically connected with the master control module and the MOS transistor;
where the master control module is configured for controlling an on-state and an on-time of the braking control unit according to the detection signal and the braking force intensity level, and an on-state of the MOS transistor is synchronized with the on-state of the braking control unit.

In one embodiment, the braking system further includes:
a magnetic piece, where the magnetic piece is configured for integrally rotating with the spool, and where the braking piece is also configured for generating an alternating current electric signal in a rotating state of the magnetic piece; and
a power supply module, where the power supply module is electrically connected with the braking piece, and is configured for filtering and rectifying the alternating current electric signal to obtain a power supply for the detecting device and the control device.

In some embodiments, the magnetic piece includes a first magnet and a second magnet with opposite magnetic poles, and the first magnet and the second magnet are alternately arranged on a spool shaft in a radial direction.

In some embodiments, the power supply module includes:
a rectifying unit, where the rectifying unit is electrically connected with the braking piece, and configured for rectifying the alternating current electric signal to obtain a second electric signal;
a filtering unit, where the filtering unit is electrically connected with the rectifying unit, and configured for filtering the second electric signal to obtain a third electric signal;
a first voltage stabilizing unit, where the first voltage stabilizing unit is configured for converting the third electric signal into a first power supply for the control device; and
a second voltage stabilizing unit, where the second voltage stabilizing unit is electrically connected with the first voltage stabilizing unit, and is configured for converting the first power supply into a second power supply for the master control module and the detecting device.

In some embodiments, the braking piece includes a plurality of coils connected in series, where a first coil and a tail coil of the plurality of coils are electrically connected with the power supply module;

where, the detecting device is arranged at a site diametrically opposed to an alternating site of any two coils.

In some embodiments, the coil is arranged in a direction perpendicular to a magnetic field direction generated by the magnetic piece.

In the braking system for the fishing reel provided by the present disclosure, the control device flexibly controls the braking force of the braking piece according to the detection signal generated by the detecting device. That is, the present disclosure can control the braking force to gradually increase according to the increase of the rotation speed, and can control the braking force to gradually decrease according to the decrease of the rotation speed after the rotation speed reaches maximum. In this way, the braking force can be smoothed on the basis of realizing the braking control of the fishing reel. Compared with the related art, when the rotation speed of the fishing reel rises to a certain set speed, the braking force suddenly changes to the maximum value, and when the rotation speed reaches the maximum value, the braking force suddenly drops (for example, suddenly changes to 30% to 50% of the maximum value), so the embodiments of the present disclosure can reduce the kinetic energy loss.

### BRIEF DESCRIPTION OF THE DRAWINGS

FIG. 1 is a schematic structural diagram of a braking system provided by embodiments of the present disclosure;

FIG. 2 is a schematic diagram for flexible control of a braking force provided by the embodiments of the present disclosure;

FIG. 3 is a flow chart for flexible control of the braking force provided by the embodiments of the present disclosure;

FIG. 4 is another schematic structural diagram of the braking system provided by the embodiments of the present disclosure; and

FIG. 5 is a schematic structural diagram of the braking system provided by the embodiments of the present disclosure.

Reference numerals: 110—braking piece, 120—spool, 130—detecting device, 140—control device, 141—braking-dial adjusting device, 142—braking control switch, 143—master control module, 150—magnetic piece, 160—power supply module, 161—rectifying unit, 162—filtering unit, 163—first voltage stabilizing unit, and 164—second voltage stabilizing unit.

### DETAILED DESCRIPTION

Embodiments of the present disclosure will be described in detail below. Examples of the embodiments are illustrated in the accompanying drawings, where the same or like reference numerals throughout the figures indicate the same or like elements having the same or like functions. The embodiments described below with reference to the accompanying drawings are exemplary and are intended only to explain the present disclosure instead of being construed as limiting the present disclosure.

In the description of the present disclosure, it should be understood that, descriptions relating to orientation, for example, orientation or positional relationships indicated by “up”, “down”, “front”, “rear”, “left”, “right”, etc. are based on the orientation or positional relationships shown in the accompanying drawings, and are to facilitate the description of the present disclosure and simplify the description only, rather than indicating or implying that the device or element referred to must have a specific orientation or be constructed and operated in a specific orientation, and therefore cannot be construed as limiting the present disclosure.

In the description of the present disclosure, the meaning of “several” is one or more, the meaning of “a plurality of” is two or more, “greater than”, “less than”, “more than”, etc. are to be understood to exclude the given figure, and “above”, “below”, “within”, etc. are understood to include the given figure. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, unless otherwise explicitly defined, the words such as “set”, “install”, and “connect” should be understood in a broad sense, and those of ordinary skill in the art can determine the specific meanings of the above words in the present disclosure in a rational way in combination with the specific contents of the technical solutions.

In a fishing reel, such as a baitcasting reel, excessive spool rotation speed during a cast can cause the line to leave the spool faster than the lure travels. This causes the line to bunch up around the spool, resulting in “backlash”. To prevent this, a brake system is mounted that applies braking force to the spool.

When the rotation speed of the spool rises to a certain set speed, a braking force suddenly changes to a maximum value. Moreover, when the rotation speed reaches its maximum value, the braking force suddenly drops, for example, suddenly changes to 30% to 50% of the maximum value. The braking mode will lead to braking force fluctuation. Moreover, the braking mode will lead to kinetic energy loss and affect a throwing distance during rising. When the rotation speed reaches the maximum, the braking force decreases, which tends to increase a backlash probability of the fishing line.

In view of this, a braking system for a fishing reel is provided in the embodiments of the present disclosure, which is intended to realize smooth braking of the fishing reel.

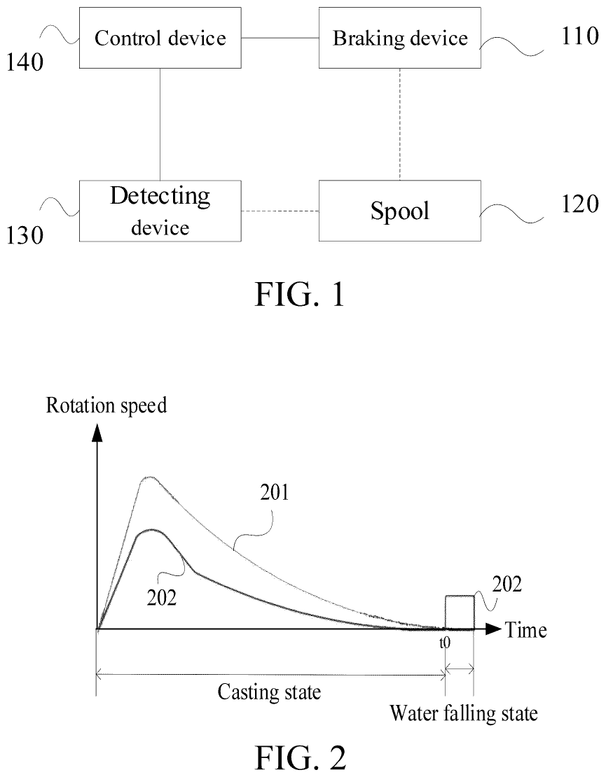

As shown in FIG. 1, a braking system for a fishing reel is provided by an embodiment of the present disclosure. The braking system includes a braking piece 110, a detecting device 130 and a control device 140. The braking piece 110 is configured for braking the spool 120. The detecting device 130 is configured for generating a detection signal according to a rotation speed of the spool 120. The control device 140 is electrically connected with the detecting device 130 and the braking piece 110 respectively, and configured for flexibly controlling a braking force of the braking piece 110 according to the detection signal.

It can be understood that the fishing reel may include a spool assembly and a fishing line may be wound in the spool 120. During casting, the spool 120 rotates to release the fishing line. In the process of releasing the fishing line, the fishing line may be entangled, so the braking system is needed to brake the rotation of the spool 120. In addition, by controlling the rotation speed of the spool 120 by braking, a flying distance of bait can be increased when the fishing rod is cast, and a fishing success rate can be improved. The braking system provided by the embodiments of the present disclosure includes a braking piece 110, a detecting device 130 and a control device 140. The detecting device 130 is configured for detecting the rotation speed of the spool 120, and generating a corresponding detection signal, for example, generating a corresponding square wave signal. The control device 140 is configured for receiving the detection signal, calculating the rotation speed of the spool 120 according to the detection signal, and generating a corresponding control signal according to the rotation speed and a preset control strategy. The control signal is intended for controlling the braking force of the braking piece 110 when braking the spool 120, so as to realize braking control of the spool 120. The preset control strategy of the control device 140 can be a flexible control strategy, that is, when the control device 140 determines that the rotation speed of the spool 120 is in an increasing state according to the detection signal, the generated control signal is allowed to control the braking force to gradually increase; and when the control device 140 determines that the rotation speed of the spool 120 reaches a maximum speed and shows a descending state according to the detection signal, the generated control signal is allowed to control the braking force to gradually decrease. In this way, compared with the related art in which when the rotational speed of the spool 120 rises to a certain set speed, the braking force suddenly changes to a maximum value, and when the rotation speed reaches the maximum value, the braking force suddenly drops (for example, suddenly changes to 30% to 50% of the maximum value), the embodiments of the present disclosure can smoothly control the braking force as shown in FIG. 2. FIG. 2 shows a rotation speed curve 201 of the spool 120 and a braking force curve 202. The embodiments of the present disclosure can reduce a kinetic energy loss according to the method of controlling the braking force to gradually increase with the increase of the rotation speed. In the embodiments of the present disclosure, after the rotation speed reaches the maximum, the method of controlling the braking force to gradually decrease according to the decrease of the rotation speed can reduce a backlash probability of the fishing line.

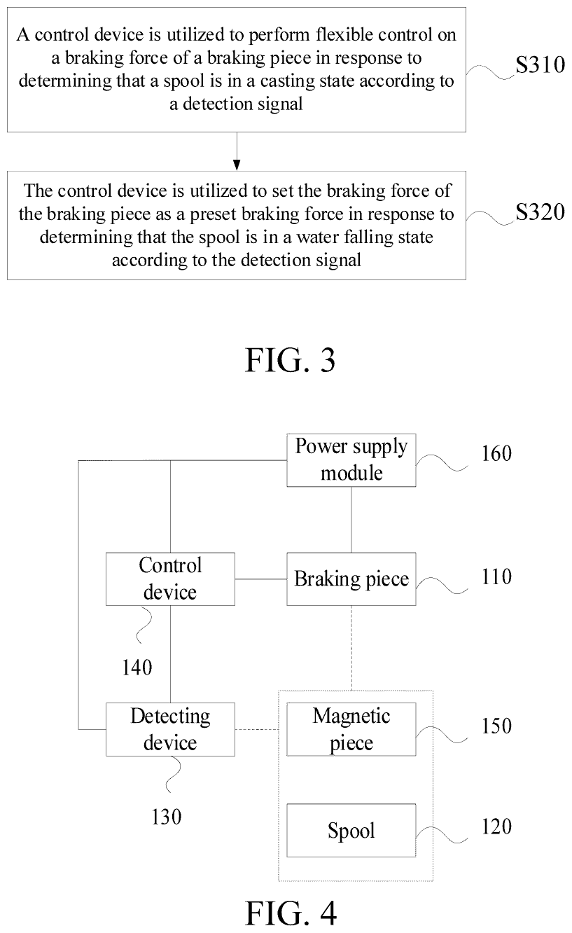

As shown in FIG. 3, in some embodiments, the flexible control method for the control device 140 may include, but is not limited to step S301 to step S302.

At step S301, the control device is utilized to perform flexible control on the braking force of the braking piece in response to determining that the spool is in a casting state according to the detection signal.

At step S302, the control device is utilized to set the braking force of the braking piece as a preset braking force in response to determining that the spool is in a water falling state according to the detection signal.

In steps S301 to S302 according to some embodiments, the control device 140 can determine whether the fishing line is in a casting state or a water falling state according to the detection signal. For example, as shown in FIG. 2, when the control device 140 determines that the rotation speed of the spool 120 gradually increases from zero according to the detection signal, it may be considered that the spool is in a casting state where the spool 120 rotates to release the fishing line. When the control device 140 determines that the rotation speed of the spool 120 changes from increasing to decreasing according to the detection signal, and a decreasing rotation speed is less than a preset value, it can be considered that the fishing line is in a water falling state. It can be understood that when the bait enters the water, the fishing line will not be paid off, but the spool 120 will continue to rotate under the influence of inertia. Therefore, the state when the rotation speed is less than the preset value can be judged as the water falling state of the fishing line, that is, the water falling state of the bait. It can be understood that a specific value of the preset value can be adaptively set according to an actual situation, which is not specifically limited by the embodiments of the present disclosure.

The control device 140 can perform flexible control on the braking force when the casting state is determined. That is, when the control device 140 determines that the rotation speed is in an increasing state according to the detection signal, the generated control signal can control the braking force to gradually decrease. When the control device 140 determines that the rotation speed reaches the maximum speed and shows a descending state according to the detection signal, the generated control signal can control the braking force to gradually decrease.

When the water falling state is determined, the control device 140 can set the braking force as the preset braking force. The preset braking force can be greater than the braking force at the last moment of the throwing state. As shown in FIG. 2, the preset braking force can be greater than the braking force at the moment of t0. When the braking force is set to the preset braking force, the braking force curve 202 will take a shape of a square wave. It can be understood that a specific value of the preset braking force can be adaptively set according to an actual situation, which is not specifically limited by the embodiments of the present disclosure.

The advantages of steps S301 to S302 are that the braking force can be flexibly controlled in the throwing state and the kinetic energy loss can be reduced. In addition, the braking force can be set as the preset braking force in the water falling state, thus reducing a chance of fishing line backlash during water falling.

As shown in FIG. 4, in some embodiments, the braking system further includes a magnetic piece 150 and a power supply module 160. The magnetic piece 150 is configured for integrally rotating with the spool 120, and the braking piece 110 is configured for generating an alternating current electric signal in a rotating state of the magnetic piece 150. The power supply module 160 is electrically connected with the braking piece 110, and is configured for filtering and rectifying the alternating current electric signal to obtain a power supply for the detecting device 130 and the control device 140.

In some embodiments, the magnetic piece 150 may refer to a component that has magnetism and can generate a magnetic field. In an example, the magnetic piece 150 may refer to a permanent magnet. The magnetic piece 150 may be disposed on the spool 120, and when the spool 120 rotates, the magnetic piece 150 can rotate integrally with the spool 120. When the magnetic piece 150 is rotating, the braking piece 110 can generate an alternating current electric signal based on the magnetic field, thereby realizing conversion of mechanical energy into electric energy. In an implementation, the braking piece 110 includes a coil, which is arranged perpendicular to the magnetic field. When the magnetic piece 150 is rotating, the coil will cut a magnetic line of force and start to generate the alternating current electric signal. The power supply module 160 is electrically connected with the braking piece 110, and is capable of filtering and rectifying the alternating current electric signal to obtain a power supply capable of driving the detecting device 130 and the control device 140 to work stably.

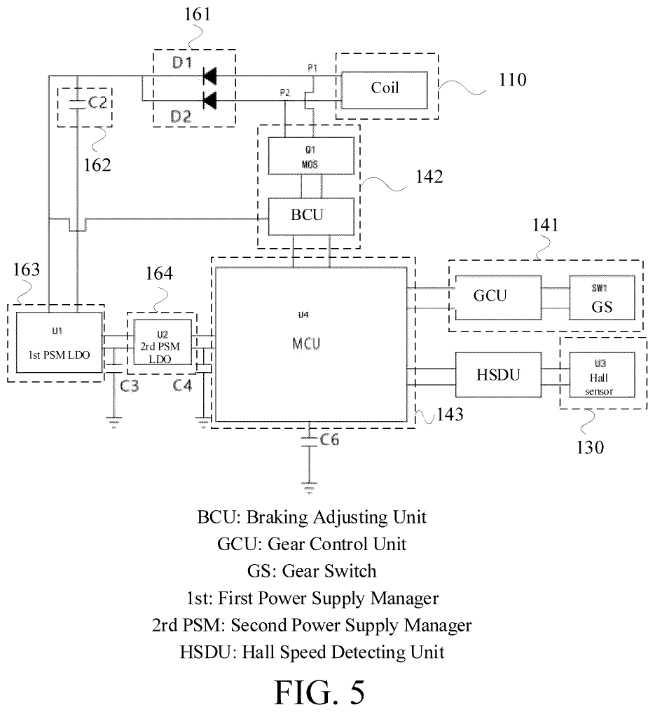

It can be understood that the detecting device 130 can start to work based on the power supply, so as to detect the rotation speed of the spool 120. As shown in FIG. 5, according to characteristics of the magnetic piece 150, the detecting device 130 can include a Hall sensor U3. The Hall sensor U3 can generate a pulse signal (i.e., detection signal) according to the rotation of the spool 120, and the control device 140 can determine the rotation speed of the spool 120 based on the pulse signal and generate a corresponding control signal according to the rotation speed. It can be understood that the Hall sensor U3 may adopt ultra-low power-consumption latching bipolar Hall switch and Tunnel Magneto-Resistance (TMR) technology, which makes the Hall sensor U3 have the characteristics of ultra-high frequency response (such as 1 KHz), ultra-high sensitivity and high resistance to external magnetic field interference.

In some embodiments, the magnetic piece 150 can include a first magnet and a second magnet with opposite magnetic poles, and the first magnet and the second magnet are alternately arranged on a shaft of the spool 120 in a radial direction of an axis.

In some embodiments, the magnetic piece 150 can include a plurality of magnets such as a first magnet and a second magnet. A magnetic pole of the first magnet is opposite to that of the second magnet. In an example, the magnetic pole of the first magnet is a south pole, and the magnetic pole of the second magnet is a north pole. In an alternative example, the magnetic pole of the first magnet is the north pole, and the magnetic pole of the second magnet is the south pole. The first magnet and the second magnet can be alternately arranged on one side surface of the spool 120 near the braking piece 110 in the radial direction. In an implementation, the magnetic piece 150 can include two first magnets and two second magnets, and the first magnets and the second magnets can be arranged on the spool 120 in a manner of first magnet (N)-second magnet (S)-first magnet (N)-second magnet(S). It can be understood that quantities of the first magnets and the second magnets can be adaptively set according to an actual situation, such as a speed detection accuracy, a size of the spool 120, or the like, which are not specifically limited in the embodiments of the present disclosure.

It can be understood that the detecting device 130, the control device 140, the power supply module 160, and the braking piece 110 can be arranged on a substrate. The substrate can be arranged opposite to the spool 120, that is, the substrate and the spool 120 can be separated by a certain distance. Specifically, the coil of the braking piece 150 can be a hollow coil. The magnetic piece 150 is provided on the spool 120, and the substrate may be arranged at a certain distance outside the magnetic piece 150. That is, the spool 120 and the magnetic piece 150 may be arranged in an enclosed area of the coil of the braking piece 150. In this way, when the spool 120 rotates, the magnetic piece 150 rotates integrally with the spool 120, while the spool 120 rotates relative to the substrate.

Elements and devices included in the braking piece 110, the detecting device 130, the control device 140 and the power supply module 160 will be described in detail as follows.

As shown in FIG. 5, in some embodiments, the braking piece 110 can include a plurality of coils connected in series, where the first coil and the tail coil connected in series are electrically connected with the power supply module 160. In an example, the braking piece 110 can include a coil L1, a coil L2, a coil L3 and a coil L4, and the coils L1 to L4 are sequentially connected in series. The first coil (such as coil L1) and the tail coil (such as coil L4) are electrically connected with the power supply module 160 respectively. Specifically, a terminal P1 of the coil L1 and a terminal P2 of the coil L4 are electrically connected with the power supply module 160 respectively. It can be understood that the control device 140 may start braking and end braking by controlling energizing and de-energizing of the coil.

It can be understood that the detecting device 130 can be arranged at a site opposite to where any two coils alternate, i.e., a site diametrically opposed to the alternating site of any two coils to detect the magnetic pole transitions at the alternating site. In an example, the detecting device can be arranged at a site diametrically opposed to the alternating site between the coil L1 and the coil L2, or at a site diametrically opposed to the alternating site between the coil L3 and the coil L4.

The detecting device 130 in the embodiments of the present disclosure is arranged at a site diametrically opposed to the alternating site of any two coils to detect magnetic pole transition. In this way, the control device 140 controls positions where the braking force is generated by the braking piece 110 as to be behind the alternating site according to the detection signal, that is, all at the same position. Therefore, the control of position where the braking force is generated in the embodiments of the present disclosure is fixed, and the braking force generated after outputting the same braking force signal every time is also constant. Compared with the related art in which the braking force is controlled at a random position, the embodiments of the present disclosure can reduce fluctuation caused by control at random position and an instability of braking force, improving smoothness of braking control.

In some embodiments, the control device 140 includes a braking-dial adjusting device 141, a braking control switch 142 and a master control module 143. The braking-dial adjusting device 141 is configured for setting a braking level. The braking control switch 142 is electrically connected with the braking piece 110. The master control module 143 is electrically connected with the braking-dial adjusting device 141, the braking control switch 142 and the detecting device 130 respectively. The master control module 143 is configured for controlling an on-state and an on-time of the braking control switch 142 according to the detection signal and the braking level, so as to flexibly control the braking force of the braking piece 110.

In some embodiments, the braking-dial adjusting device 141 can refer to a switch for setting a braking force intensity level, and different braking levels can correspond to different magnitude of braking forces. For example, braking levels 0 to 9 may be included, and braking force ranges set by the levels 0 to 9 may be increased in turn, that is, the level 9 may correspond to a maximum braking force range.

The master control module 143 may control the on-state and the on-time of the braking control switch 142 according to the braking force intensity level and the detection signal. The master control module 143 may include an MCU (i.e., element U4). The braking control switch 142 may be intended for controlling a braking state of the braking piece 110. For example, when the on-state of the braking control switch 142 is on, the braking state of the braking piece 110 may be braking, that is, the braking control switch 142 may control the coil to be energizing. When the on-state of the braking control switch 142 is off, the braking state of the braking piece 110 may be non-braking, that is, the braking control switch 142 may control the coil to be de-energizing. In addition, a size of the braking force may be controlled through the on-time. For example, the longer the on-time of the braking control switch 142, the greater the braking force of the braking piece 110 on the spool 120.

It can be understood that when the fishing line is in a casting state, the master control module 143 may determine the rotation speed of the spool 120 according to the detection signal, and control the on-time of the braking control switch 142 according to the rotation speed and the braking level. For example, when the master control module 143 determines that the rotation speed is in an increasing state according to the detection signal, the master control module 143 can determine the braking force range according to the corresponding braking force intensity tap position, and the master control module 143 generates a corresponding control signal according to the braking force range and the rotation speed of the spool 120 to control the braking force to gradually increase. Similarly, when the master control module 143 determines that the rotation speed reaches the maximum speed and shows a decreasing state according to the detection signal, the master control module 143 can determine the braking force range according to the corresponding braking force intensity level, and the master control module 143 generates a corresponding control signal according to the braking force range and the rotation speed of the spool 120 to control the braking force to gradually decrease.

In some embodiments, the braking control switch 142 may include a braking control unit and an MOS transistor. The braking control unit is configured to be electrically connected with the master control module 143. The MOS transistor is electrically connected with the braking control unit and the braking piece respectively. The master control module is configured for controlling an on-state and an on-time of the braking control unit according to the detection signal and the braking force intensity level, and an on-state of the MOS transistor is synchronized with the on-state of the braking control unit.

In some embodiments, the braking control switch 142 includes a braking control unit and an MOS transistor Q1. The braking control unit is electrically connected with the master control module 143, while the MOS transistor Q1 is electrically connected with two terminals (i.e., terminal P1 and terminal P2) of the braking piece 110. The master control module 143 can control the on-state of the braking control unit according to the detection signal and the braking force intensity level, thus controlling an on-state of the MOS transistor Q1, thereby controlling the braking state of the braking piece 110. Specifically, when the braking control unit is turned on according to the control signal of the master control module 143, the MOS transistor Q1 is turned on, and in this case, the braking piece 110 is activated to start braking. When the braking control unit is turned off according to the control signal of the master control module 143, the MOS transistor Q1 is turned off, and in this case, the braking piece 110 is deactivated to end braking. By controlling the on-time of the braking control unit, the braking force of the braking piece 110 on the spool 120 can be controlled.

It can be understood that the braking control switch 142 also includes other elements and devices (such as resistor, capacitor, and the like), and a connection relationship of these elements and devices will not be described in detail in the embodiments of the present disclosure. Furthermore, the braking control unit may include triodes and other elements with on-off control characteristics.

In some embodiments, the power supply module 160 includes a rectifying unit 161, a filtering unit 162, a first voltage stabilizing unit 163 and a second voltage stabilizing unit 164. The rectifying unit 161 is electrically connected with the braking piece 110, and configured for rectifying the alternating current electric signal to obtain a second electric signal. The filtering unit 162 is electrically connected with the rectifying unit 161, and configured for filtering the second electric signal to obtain a third electric signal. The first voltage stabilizing unit 163 is configured for converting the third electric signal into a first power supply for the control device 140. The second voltage stabilizing unit 164 is electrically connected with the first voltage stabilizing unit 163, and is configured for converting the first power supply into a second power supply for the detecting device 130.

In some embodiments, the rectifying unit 161 may include a Schottky diode (comprising a diode D1 and a diode D2 and two diodes inside the MOS transistor. The MOS transistor may refer to the MOS transistor Q1 in the braking control switch 142. The Schottky diode and the two diodes inside the MOS transistor can form bridge rectifier. When the alternating current electric signal generated at both terminals of the braking piece 110 (i.e., terminal P1 and terminal P2) reaches an on-threshold of the Schottky diode, the Schottky diode conducts. The rectifying unit 161 converts the alternating current electric signal into a direct current second electrical signal.

The filtering unit 162 may include a capacitor C2. One end of the capacitor C2 is electrically connected with the Schottky diode, and the other end of the capacitor C2 is grounded. The capacitor C2 is intended for filtering the rectified voltage (i.e., the second electrical signal) and obtaining a smooth direct current (i.e., the third electrical signal). It can be understood that the capacitor C2 may also store energy, and when the alternating current electric signal is insufficient, power can be supplied based on the energy stored in the capacitor C2.

The first voltage stabilizing unit 163 may include a first power supply manager LDO (i.e., element U1). An input end of the element U1 is electrically connected with one end of the capacitor C2. The element U1 can convert a higher direct current voltage (i.e., the third electrical signal) into a first power supply, for example, the first power supply is a 5V voltage signal. The first power supply can drive the braking control switch 142.

The second voltage stabilizing unit 164 may include a second power supply manager LDO (i.e., element U2). An input end of the element U2 is electrically connected with an output end of the element U1. The element U2 can convert the first power supply into a second power supply, for example, the second power supply is a 3V voltage signal. The second power supply can drive the master control module 143 and the detecting device 130. It can be understood that the element U4 included in the master control module 143 may be an ultra-low power-consumption MCU of an ARM framework. In this way, a running time delay of the master control module 143 is less, and the master control module can work with weak electric energy, and can be initialized and enter a working state quickly, so that data can be collected and processed more quickly, and corresponding control signals are output. For example, when the second power supply reaches 1.8V, it reaches a minimum rated voltage of the master control module 143 and the detecting device 130, and the master control module 143 and the detecting device 130 start working (in fact, when the second power supply is lower than 1.8 V, the master control module 143 and the detecting device 130 already start working).

It can be understood that the power supply module 160 may also include a capacitor C3, a capacitor C4 and a capacitor C6, and connection modes of these capacitors and other elements may be shown in FIG. 5, which will not be described in detail in the embodiments of the present disclosure.

According to the braking system for the fishing reel provided by the embodiments of the present disclosure, the master control module with ultra-low power-consumption and the high-efficiency bridge rectifier circuit are adopted, so that the braking system can be quickly started, and an extra booster circuit is not required. By flexible control on the braking force, a smooth braking force can be output, thus reducing the kinetic energy loss and the backlash probability of the fishing line.

The embodiments described in the embodiments of the present disclosure are only for the purpose of more clearly explaining the technical schemes of the present disclosure and do not constitute a limitation to the technical schemes provided by the present disclosure. Those of ordinary skill in the art can understand that with the evolution of the technologies and the emergence of new application scenarios, the technical schemes provided by the embodiments of the present disclosure are also applicable to similar technical problems.

Those skilled in the art can understand that the technical scheme shown in the drawings does not constitute a limitation to the embodiments of the present disclosure, and may include more or less steps than the illustrated steps, or combine some steps, or have different steps.

The device embodiments are illustrative only, where the units described as separated parts may or may not be physically separated, that is, may be located in the same place, or may be distributed on multiple network units. Some or all of the modules may be selected according to actual needs to achieve the objectives of the scheme of the embodiments.

Those of ordinary skills in the art will appreciate that all or some of the steps of method, functional modules/units in systems and devices disclosed above may be implemented as software, firmware, hardware, and suitable combinations thereof.

The terms “first”, “second”, “third”, “fourth” and the like (if used) in the specification and claims of the present disclosure as well as the above drawings are used to distinguish similar objects, and are not necessarily used to describe a specific sequence or a chronological order. It is to be understood that the data used in such way may be interchanged where appropriate so that the embodiments of the present disclosure described herein can be implemented in an order other than what is illustrated or described herein. In addition, the terms “include” and “have” and any variant thereof are intended to cover a non-exclusive inclusion, for example, a process, method, system, product, or device that includes a series of steps or units is not necessarily limited to those steps or units that are explicitly listed, but may include other steps or units that are not explicitly listed or inherent to such process, method, product or device.

It should be understood that in the present disclosure, “at least one” means one or more, and “a plurality of” means two or more than two. “And/or” is used for describing an association relationship of associated object, indicating that there may be three relationships, for example, “A and/or B” may indicate: there are only A, only B and both A and B, where A and B may be singular or plural. The character “/” generally indicates that the contextual objects are in an “or” relationship. “At least one of the followings” and similar expressions refer to any combination of these terms, including any combination of a singular or plural term. For example, at least one of a, b or c may indicate a alone, b alone or c alone, “a and b”, “a and c”, “b and c”, or “a, b and c”, where a, b and c may be single or multiple.

In the several embodiments provided in the present disclosure, it should be understood that the disclosed device and method may be implemented in other manners. For example, the apparatus embodiments described above are merely illustrative. For example, the division of the units is only a logical function division. In practice, there may be another division manner. For example, multiple units or components may be combined or integrated into another system, or some features may be ignored or not executed. In addition, the illustrated or discussed mutual coupling or direct coupling or communication connection may be indirect coupling or communication connection through some interfaces, devices or units, and may be in electrical, mechanical or other forms.

The units described as separated parts may or may not be physically separated, and the parts displayed as units may or may not be physical units, that is, may be located in the same place, or may be distributed on multiple network units. Some or all of the units may be selected according to actual needs to achieve the objectives of the schemes of the embodiments.

The embodiments of the embodiments of the present disclosure have been described above with reference to the attached drawings, and the scope of rights of the embodiments of the present application is not limited thereby. Any modifications, equivalents, and improvements without departing from the scope and gist of the embodiments of the present disclosure are intended to be included within the scope of the present disclosure.

What is claimed is:

1. A braking system for a fishing reel comprising a spool, comprising:
a braking piece, wherein the braking piece is configured for braking the spool;
a detecting device, wherein the detecting device is configured for generating a detection signal according to a rotation speed of the spool; and
a control device, wherein the control device is electrically connected with the detecting device and the braking piece respectively, and configured for performing a flexible control on a braking force of the braking piece according to the detection signal.

2. The braking system according to claim 1, wherein the control device configured for performing the flexible control on the braking force of the braking piece according to the detection signal is further configured to:
perform the flexible control on the braking force of the braking piece, in response to determining that the spool is in a casting state according to the detection signal; and
set the braking force of the braking piece as a preset braking force, in response to determining that the spool is in a water falling state according to the detection signal.

3. The braking system according to claim 1, wherein the control device comprises:
a braking-dial adjusting device, wherein the braking-dial adjusting device is configured for setting a braking force intensity level;
a braking control switch, wherein the braking control switch is electrically connected with the braking piece; and
a master control module, wherein the master control module is electrically connected with the braking-dial adjusting device, the braking control switch and the detecting device respectively, and is configured for controlling an on-state and an on-time of the braking control switch according to the detection signal and the braking force intensity level, so as to perform the flexible control on the braking force of the braking piece.

4. The braking system according to claim 3, wherein the braking control switch comprises:
an MOS transistor, wherein the MOS transistor is electrically connected with the braking piece; and
a braking control unit, wherein the braking control unit is electrically connected with the master control module and the MOS transistor;
wherein the master control module is configured for controlling an on-state and an on-time of the braking control unit according to the detection signal and the braking force intensity level, and an on-state of the MOS transistor is synchronized with the on-state of the braking control unit.

5. The braking system according to claim 1, wherein the braking system further comprises:
a magnetic piece, wherein the magnetic piece is configured for integrally rotating with the spool, and wherein the braking piece is configured for generating an alternating current electric signal in a rotating state of the magnetic piece; and
a power supply module, wherein the power supply module is electrically connected with the braking piece, and is configured for filtering and rectifying the alternating current electric signal to obtain a power supply for the detecting device and the control device.

6. The braking system according to claim 5, wherein the magnetic piece comprises a first magnet and a second magnet with opposite magnetic poles, and the first magnet and the second magnet are alternately arranged on a spool shaft in a radial direction.

7. The braking system according to claim 5, wherein the power supply module comprises:
a rectifying unit, wherein the rectifying unit is electrically connected with the braking piece, and configured for rectifying the alternating current electric signal to obtain a second electric signal;
a filtering unit, wherein the filtering unit is electrically connected with the rectifying unit, and configured for filtering the second electric signal to obtain a third electric signal;
a first voltage stabilizing unit, wherein the first voltage stabilizing unit is configured for converting the third electric signal into a first power supply for the control device; and
a second voltage stabilizing unit, wherein the second voltage stabilizing unit is electrically connected with the first voltage stabilizing unit, and is configured for converting the first power supply into a second power supply for the detecting device.

8. The braking system according to claim 5, wherein the braking piece comprises a plurality of coils connected in series, wherein a first coil and a tail coil of the plurality of coils are electrically connected with the power supply module; and
wherein, the detecting device is arranged at a site diametrically opposed to an alternating site of any two coils.

9. The braking system according to claim 8, wherein the coil is arranged in a direction perpendicular to a magnetic field direction generated by the magnetic piece.

10. The braking system according to claim 2, wherein the braking system further comprises:
a magnetic piece, wherein the magnetic piece is configured for integrally rotating with the spool, and wherein the braking piece is configured for generating an alternating current electric signal in a rotating state of the magnetic piece; and
a power supply module, wherein the power supply module is electrically connected with the braking piece, and is configured for filtering and rectifying the alternating current electric signal to obtain a power supply for the detecting device and the control device.

11. The braking system according to claim 3, wherein the braking system further comprises:
a magnetic piece, wherein the magnetic piece is configured for integrally rotating with the spool, and wherein the braking piece is configured for generating an alternating current electric signal in a rotating state of the magnetic piece; and
a power supply module, wherein the power supply module is electrically connected with the braking piece, and is configured for filtering and rectifying the alternating current electric signal to obtain a power supply for the detecting device and the control device.

12. The braking system according to claim 4, wherein the braking system further comprises:
a magnetic piece, wherein the magnetic piece is configured for integrally rotating with the spool, and wherein the braking piece is configured for generating an alternating current electric signal in a rotating state of the magnetic piece; and
a power supply module, wherein the power supply module is electrically connected with the braking piece, and is configured for filtering and rectifying the alternating current electric signal to obtain a power supply for the detecting device and the control device.
